(19) United States
(12) Patent Application Publication
(10) Pub. No.: US 2015/0278436 A1
(43) Pub. Date: Oct. 1, 2015

(54) Methods For Evaluating Effects Of A Treatment On Biological Processes And Pathways

(71) Applicant: The Procter & Gamble Company, Cincinnati, OH (US)

(72) Inventor: Makio Tamura, Cincinnati, OH (US)

(21) Appl. No.: 14/669,011

(22) Filed: Mar. 26, 2015

Related U.S. Application Data
(60) Provisional application No. 61/971,062, filed on Mar. 27, 2014.

(51) Int. Cl. G06F 19/18

(52) U.S. Cl. CPC G06F 19/18

(57) ABSTRACT

Provided are methods, systems and apparatus for identifying mechanisms of actions of agents with desired biological activity. Specifically, the methods, systems, and apparatus identify the target biological processes and pathways through which a beneficial treatment effect is accomplished by an ingredient or compound of interest. For each of a set of target biological processes and pathways, a treatment vector representing the difference in expression of the genes of the biological process or pathway when treated with the ingredient or compound of interest is compared to a clinical vector representing the difference in the expression of genes in the presence or absence of a clinical condition. Vector distance between the two vectors is compared to vector distances for other compounds and/or biological processes and pathways to determine the significance of the effect of the ingredient or compound of interest on the particular biological process or pathway.

### BACKGROUND OF THE INVENTION

It is well known to study the effects of an ingredient or compound employed in the treatment of a particular condition. Many methods exist for identifying active ingredients for delivering various benefits. For example, connection mapping is a well-known hypothesis generating and testing tool having successful application in the fields of operations research, computer networking, and telecommunications. The undertaking and completion of the Human Genome Project and the parallel development of very high throughput, high-density DNA microarray technologies resulted in the generation of an enormous genetic data base. At the same time, the search for new pharmaceutical actives via in silico methods such as molecular modeling and docking studies stimulated the generation of vast libraries of potential small molecule actives. The amount of information linking disease to genetic profile, genetic profile to drugs, and disease to drugs grew exponentially, and application of connectivity mapping as a hypothesis testing tool in the medicinal sciences ripened.

The general notion that functionality could be accurately determined for previously uncharacterized genes, and that potential targets of drug agents could be identified by mapping connections in a data base of gene expression profiles for drug-treated cells, was spearheaded in 2000 with publication of a seminal paper by T. R. Hughes et al. (“Functional discovery via a compendium of expression profiles” Cell 102, 109-126 (2000)), followed shortly thereafter with the launch of The Connectivity Map Project by Justin Lamb and researchers at MIT (“Connectivity Map: Gene Expression Signatures to Connect Small Molecules, Genes, and Disease,” Science, Vol 313 (2006). In 2006, Lamb's group began publishing a detailed synopsis of the mechanics of “C-Map” construction, installments of the reference collection of gene expression profiles used to create the first generation C-Map, and the initiation of an on-going large scale community C-Map project, which is available under the supporting materials hyperlink at http://www.sciencemag.org/content/313/5795/1929/suppl/DC1.

Modern connectivity mapping, with its rigorous mathematical underpinnings and aided by modern computational power, has resulted in confirmed medical successes with identification of new agents for the treatment of various diseases including cancer. However, despite being one of several successful methods for identifying active ingredients that convey particular therapeutic benefits, connectivity mapping and other such methods are unable to identify detailed mechanisms of action by which the ingredients and compounds work to deliver the corresponding therapeutic benefits.

### SUMMARY OF THE INVENTION

The invention provides novel methods, apparatus, and systems useful for identifying effects of treatment agents on specific biological processes and/or pathways, for exploring relative strengths of different Mechanisms of Action of the treatment, and for mapping those effects and strengths to consumer-relatable benefits. In particular, the disclosure describes a tool useful for comparing multiple mechanisms of action of a particular treatment to determine which, if any, is primary, is particularly interesting, etc. The inventive methods, apparatus, and systems are suitable for, e.g., identifying agents efficacious in the treatment of various conditions and, in particular, identifying in what way(s) (i.e., via which biological pathways and/or processes) the agents are efficacious in such treatment.

The present description describes embodiments which broadly include methods, apparatus, and systems for determining relationships between a treatment and the effects of the treatment on biological pathways and/or processes. The methods may be used to identify the effects of a treatment, the methods of action of the treatment, and the manifestation of the methods of action of the treatment.

A computer-implemented method for evaluating effects of a treatment includes performing analyses, using a computer processor, for each of one or more biological processes and pathways. The analyses include computing a treatment vector, a clinical vector, and a set of reference vectors. The analyses also include computing a vector distance between the treatment and clinical vectors, and computing a set of vector distances between the clinical vector and each of the set of reference vectors. The vector distance may be any distance measurement between two vectors, including, by way of example and without limitation, Euclidian distance, Mahalanobis distance, Manhattan distance, Chebyshev distance, Minkowski distance, and the like. A distribution of the set of vector distances is determined as part of analyses and, a percentile for the vector distance in the set of vector distances is calculated. In embodiments, the one or more biological processes or pathways include multiple biological processes or pathways, and the method further includes sorting the percentiles by ascending order and, optionally, selecting as a target of the effect of the treatment biological processes or pathways having lower percentiles. The method may also include identifying a mechanism of action, a technology product story, or a power claim of the treatment according to the selected biological processes or pathways. In embodiments, computing the treatment vector includes computing expression difference such as log 2 fold changes, standardized value (z-score), or t-statistic or normal quantile from p-values of genes in a biological process or pathway as a result of the treatment, and computing a clinical vector comprises computing expression difference of genes in the biological process or pathway as a result of a non-treatment variable, such as a clinical condition. The method evaluates anti-aging effects of an ingredient or compound on skin cells in some embodiments.

A system for evaluating effects of a treatment includes a computer processor and one or more memory devices coupled to the processor. The memory devices store a listing of genes associated with a target process or pathway, a set of treatment genomics data demonstrating effects of the treatment on a set of genes including at least the genes associated with the target process or pathway, a set of clinical genomics data demonstrating effects of a target characteristic on a set of genes including at least the genes associated with the target process or pathway, and a set of reference genomics data representing the effects of various materials and/or conditions on a set of genes including at least the genes associated with the target process or pathway. The memory devices also store a set of machine readable instructions that, when executed, cause the processor to compute a treatment vector using the treatment data, compute a clinical vector using the clinical data, and compute a set of reference vectors. The instructions also cause the processor to compute a vector distance between the treatment vector and the clinical vector, and to compute a set of vector distances between the clinical vector and each of the set of reference vectors. The instructions further cause the processor to determine a distribution of the set of vector distances and to calculate for the vector distance a percentile relative to the set of vector distances.

These and additional objects, embodiments, and aspects of the invention will become apparent by reference to the Figures and Detailed Description below.

### BRIEF DESCRIPTION OF THE FIGURES

While the specification concludes with claims particularly pointing out and distinctly claiming the subject matter that is regarded as the invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a schematic illustration of a computer system suitable for use with the invention;

FIG. 2 is a schematic illustration of a programmable computer suitable for use according to the present description;

FIG. 3 depicts example heat maps showing log 2 fold change data for an ingredient evaluated for anti-aging effects on two biological pathways;

FIG. 4 depicts example distributions representing a set of cosine distances as vector distances generated from reference genomics data;

FIG. 5 depicts an example heat map depicting standardized anti-aging effects of all biological processes/pathways in an example database of reference genomics data;

FIG. 6 shows example data of anti-aging treatments for a first set of biological processes and pathways;

FIG. 7 shows example data of anti-aging treatments for a second set of biological processes and pathways;

FIG. 8 shows example data of anti-aging treatments for a third set of biological processes and pathways;

FIG. 9 is a chart summarizing the example results depicted in FIGS. 6, 7, and 8;

FIG. 10 is a flow chart depicting part of an example method for evaluating effects of a treatment on biological processes and pathways according to the description; and

FIG. 11 is a flow chart depicting another part of the example method shown in FIG. 10.

### DETAILED DESCRIPTION OF THE INVENTION

The invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and to fully convey the scope of the invention to those skilled in the art.

The computational schemes described throughout this specification assess the strength of effects of ingredients quantitatively and systematically for specific biological processes and/or pathways. In an embodiment, for example, the computational scheme, embodied as computer-readable instructions stored on a tangible, computer-readable medium, and executed by a processor, quantitatively analyzes the anti-aging effects of various ingredients used in skin treatments and cosmetics. The assessment is accomplished by utilizing both vector representations of expression profiles of key genes and similarity computations of the resulting vectors according to proprietary and/or public and/or licensed genomics study data.

The results of the computational schemes and methods facilitate identification of connections between the benefits of ingredients used in past research, as well as beneficial mechanisms of action of new ingredients. For example, when applied to assess anti-aging effects of skin treatments, the described methods establish connections between anti-aging benefits of ingredients previously used and studied, or of ingredients that may be used in the future. Among the benefits of the method are that: previous products and ingredients that have proven beneficial in treating a condition can be tied to the particular methods of action and biological processes and/or pathways that have provided the benefit (e.g., explaining which biological pathways and/or processes caused a particular treatment to result in fewer wrinkles); additional ingredients may be identified based on particular methods of action and biological processes and/or pathways that are targeted (e.g., identifying ingredients that target the biological pathways and/or processes that affect the generation of wrinkles); and benefits of particular treatments can be explained to the consumer (e.g., explaining to the consumer that a particular ingredient results in fewer wrinkles, better firmness, texture, radiance, etc.).

The disclosed methodology quantifies and relates (1) genomics data of ingredients (which may include clinical study data and/or in-vitro study data); (2) clinical genomics study data comparing afflicted and non-afflicted cells (e.g., for skin aging studies, data comparing cells from young and old individuals); (3) genomics data of various chemicals in a connectivity map study; and (4) publically available, licensed, and/or proprietary sets of genes of various biological processes/pathways.

Unless otherwise defined, all technical and scientific terms used herein have the same meaning as commonly understood by one of ordinary skill in the art to which this invention pertains. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. Unless otherwise indicated, all numerical values are to be understood as being modified in all instances by the term “about.” Additionally, the disclosure of any ranges are to be understood as including the range itself and also anything subsumed therein, as well as endpoints. All numeric ranges are inclusive of narrower ranges; delineated upper and lower range limits are interchangeable to create further ranges not explicitly delineated.

As used herein, the terms “gene expression profiling” and “gene expression profiling experiment” refer to the measurement of the expression of multiple genes in a biological sample using any suitable profiling technology. Exemplary biomolecules representative of gene expression (i.e., “biomarkers”) include protein, nucleic acid (e.g., mRNA or cDNA), protein fragments or metabolites, and/or products of enzymatic activity encoded by the protein encoded by a gene transcript, and detection and/or measurement of any of the biomarkers described herein is suitable in the context of the invention.

The term “perturbagen,” as used herein, means a stimulus used as a challenge in a gene expression profiling experiment to generate gene expression data. Exemplary perturbagens include, but are not limited to, natural products, such as plant or mammal extracts; synthetic chemicals; small molecules; peptides; proteins (such as antibodies or fragments thereof); peptidomimetics; polynucleotides (DNA or RNA); drugs (e.g. Sigma-Aldrich LOPAC (Library of Pharmacologically Active Compounds) collection); and combinations thereof. Other non-limiting examples of perturbagens include botanicals (which may be derived from one or more of a root, stem bark, leaf, seed or fruit of a plant). Some botanicals may be extracted from a plant biomass (e.g., root, stem, bark, leaf, etc.) using one more solvents. A perturbagen composition (e.g., a botanical composition) may comprise a complex mixture of compounds and lack a distinct active ingredient.

By way of example, not limitation, the perturbagen is, in various aspects of the invention, a substance that is Generally Recognized as Safe (GRAS) by the U.S. Food and Drug Administration, a food additive, or a substance used in consumer products including over the counter medications. Some examples of agents suitable for use as perturbagens can be found in: the PubChem database associated with the National Institutes of Health, USA (http://pubchem.ncbi.nlm.nih.gov); the Ingredient Database of the Personal Care Products Council (http://online.personalcarecouncil.org/jsp/Home.jsp); and the 2010 International Cosmetic Ingredient Dictionary and Handbook, 13th Edition, published by The Personal Care Products Council; the EU Cosmetic Ingredients and Substances list; the Japan Cosmetic Ingredients List; the Personal Care Products Council, the SkinDeep database (URL: http://www.cosmeticsdatabase.com); the FDA Approved Excipients List; the FDA OTC List; the Japan Quasi Drug List; the US FDA Everything Added to Food database; EU Food Additive list; Japan Existing Food Additives, Flavor GRAS list; US FDA Select Committee on GRAS Substances; US Household Products Database; the Global New Products Database (GNPD) Personal Care, Health Care, Food/Drink/Pet and Household database (URL: http://www.gnpd.com); and suppliers of cosmetic ingredients and botanicals. In various embodiments, the perturbagen is pathogenic (e.g., a microbe or a virus), radiation, heat, pH, osmotic stress, and the like.

The terms “instance” and “gene expression profile record” as used herein, refer to data related to a gene expression profiling experiment. For example, in some embodiments, the perturbagen (also referred to herein as “ingredient” or “compound”) is applied to cells, gene expression is detected and/or quantified, and the resulting gene expression data are stored as an instance in a data architecture. The instance may be a “test instance,” which includes gene expression data from cells dosed with a perturbagen; a “condition instance,” which includes gene expression data from cells having a particular phenotype or biological condition under examination (e.g., cells associated with a medical disorder, such as cancer cells, cells affected by rhinovirus infection in a human, or cells infected by a virus or bacterium); or a “control instance” which includes gene expression data from cells not exposed to the perturbagen and not exhibiting a condition of interest (i.e., data from control cells). In some embodiments, the gene expression data comprise a list of identifiers representing the genes that are part of the gene expression profiling experiment. The identifiers may include gene names, gene symbols, microarray probe IDs, or any other identifier. In some embodiments, the gene expression data comprise measurements of gene expression of two or more genes as detected using one or more probes (e.g., oligonucleotide probes). In some embodiments, an instance comprises data from a microarray experiment and includes a list of probe IDs of a microarray ordered by the extent of the differential expression of the probes' target gene(s) relative to gene expression under control conditions. The gene expression data may also comprise metadata, including, but not limited to, data relating to one or more of the perturbagen, the gene expression profiling test conditions, the cells, and the microarray.

As used herein, the term “computer readable medium” refers to any tangible, non-transitory electronic storage medium and includes but is not limited to any volatile, nonvolatile, removable, and non-removable storage media implemented in any method or technology for storage of information such as computer readable instructions, data and data structures, digital files, software programs and applications, or other digital information. Computer readable media includes, but is not limited to, application specific integrated circuit (ASIC), a compact disk (CD), a digital versatile disk (DVD), a random access memory (RAM), a synchronous RAM (SRAM), a dynamic RAM (DRAM), a synchronous DRAM (SDRAM), double data rate SDRAM (DDR SDRAM), a direct RAM bus RAM (DRRAM), a read only memory (ROM), a programmable read only memory (PROM), an electronically erasable programmable read only memory (EEPROM), a disk, a carrier wave, and a memory stick. Examples of volatile memory include, but are not limited to, random access memory (RAM), synchronous RAM (SRAM), dynamic RAM (DRAM), synchronous DRAM (SDRAM), double data rate SDRAM (DDR SDRAM), and direct RAM bus RAM (DRRAM). Examples of non-volatile memory include, but are not limited to, read only memory (ROM), programmable read only memory (PROM), erasable programmable read only memory (EPROM), and electrically erasable programmable read only memory (EEPROM). A memory can store processes and/or data. Still other computer readable media include any suitable disk media, including but not limited to, magnetic disk drives, floppy disk drives, tape drives, Zip drives, flash memory cards, memory sticks, compact disk ROM (CD-ROM), CD recordable drive (CD-R drive), CD rewriteable drive (CD-RW drive), and digital versatile ROM drive (DVD ROM). As used herein, the term “computer readable storage medium” refers to any computer readable storage medium, excluding carrier waves and other transitory signals.

As used herein, the terms “software” and “software application” refer to one or more computer readable and/or executable instructions that cause a computing device or other electronic device to perform functions, actions, and/or behave in a desired manner. The instructions may be embodied in one or more various forms, such as routines, algorithms, modules, libraries, methods, and/or programs. Software may be implemented in a variety of executable and/or loadable forms and can be located in one computer component and/or distributed between two or more communicating, co-operating, and/or parallel processing computer components and thus can be loaded and/or executed in serial, parallel, and other manners. Software can be stored on one or more computer readable medium and may implement, in whole or part, the methods and functionalities of the invention.

As used herein, the term “data architecture” refers generally to one or more digital data structures comprising an organized collection of data. In some embodiments, the digital data structures can be stored as a digital file (e.g., a spreadsheet file, a text file, a word processing file, a database file, etc.) on a computer readable medium. In some embodiments, the data architecture is provided in the form of a database that may be managed by a database management system (DBMS) that is used to access, organize, and select data (e.g., gene expression profile data) stored in a database. In some embodiments, a database may be stored on a single computer readable medium, while in other embodiments, a database may be stored on and/or across more than one computer readable medium.

### I. Systems and Devices

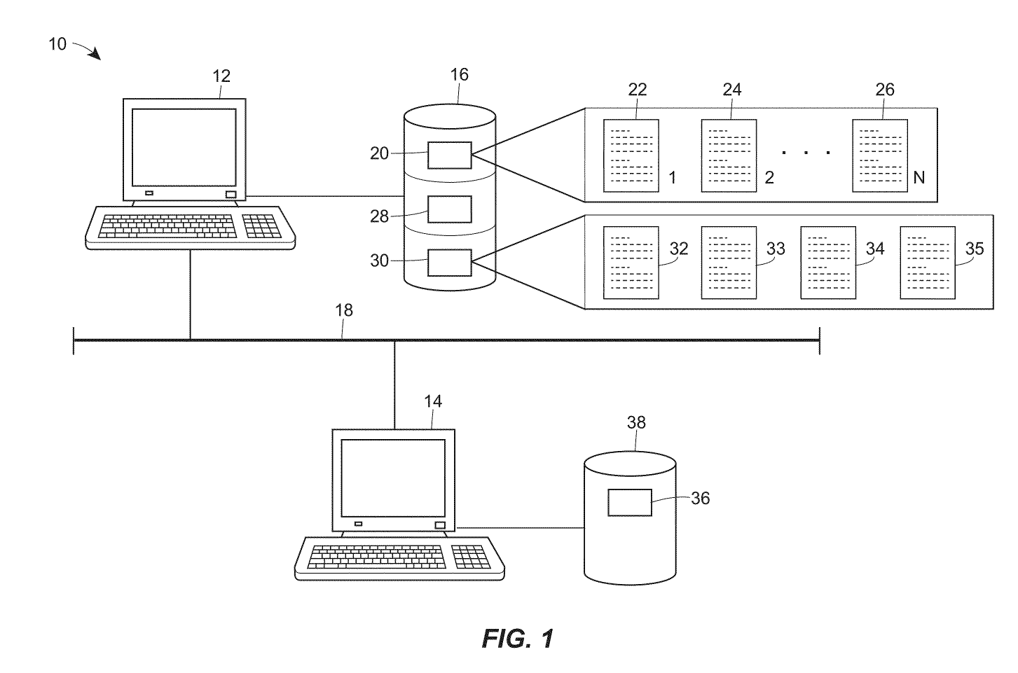

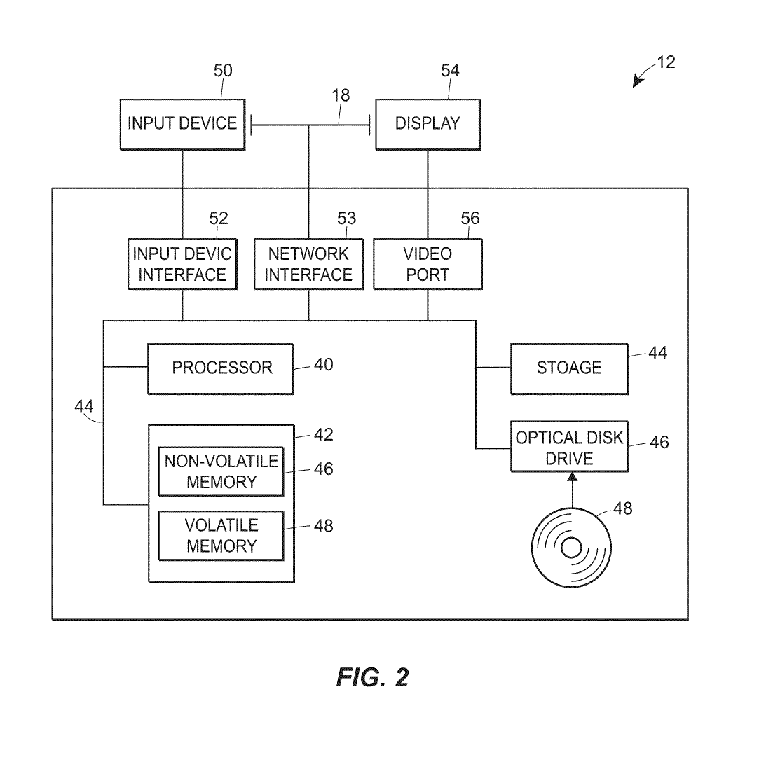

Referring to FIGS. 1 and 2 some examples of systems and devices in accordance with the invention for use in identifying relationships between perturbagens and biological processes and/or pathways will now be described. A system 10 comprises one or more computing devices 12, 14, a computer readable medium 16 associated with the computing device 12, and communication network 18.

The computer readable medium 16, which may be provided as a hard disk drive, comprises a plurality of digital files 20, such as a database files, comprising sets of genes 22, 24, and 26, each set of genes 22, 24, and 26 identifying genes in a particular target biological process or pathway, and stored as a data structure associated with the digital files 20. The plurality of gene sets may be stored in relational tables and indexes or in other types of computer readable media. While the gene set data 22, 24, and 26 may be distributed across a plurality of digital files, a single digital file 20 is exemplified herein merely for simplicity. Additionally, while gene set data 22, 24, and 26 are depicted for only three target biological processes/pathways, the digital files 20 may include data indicating sets of genes for any number of target biological processes/pathways.

The digital files 20 can be provided in wide variety of formats, including but not limited to a word processing file format (e.g., Microsoft Word), a spreadsheet file format (e.g., Microsoft Excel), and a database file format (e.g., GIF, PNG). Some common examples of suitable file formats include, but are not limited to, those associated with file extensions such as *.xls, *.xld, *.xlk, *.xll, *.xlt, *.xlxs, *.dif, *.db, *.dbf, *.accdb, *.mdb, *.mdf, *.cdb, *.fdb, *.csv, *sql, *.xml, *.doc, *.txt, *.rtf, *.log, *.docx, *.ans, *.pages, and *.wps.

Referring again to FIGS. 1 and 2, the computer readable medium 16 may also have a second digital file (or set of files) 30 stored thereon. The second digital file 30 comprises one or more sets 32 of treatment genomics data associated with one or more conditions. Each of the sets 32 of treatment genomics data comprises a set of gene expression data for cells exposed to the treatment. That is, for a given condition, a set 32 of treatment genomics data comprises gene expressions for the condition in the presence of a particular treatment. The digital file 30 may include sets 32 of treatment genomics data for a single treatment (e.g., a first ingredient or compound) or multiple treatments, and may include sets 32 of treatment genomics data for a single condition or multiple conditions. For example, a first set of the sets 32 of treatment genomics data may reflect data of gene expressions for skin cells with a first treatment for aging or age-related conditions, while a second of the sets 32 of treatment genomics data may reflect data of gene expressions for skin cells with a second treatment for aging or age-related conditions, and still others of the sets 32 of treatment genomics data may reflect data of gene expressions for skin cells with one or more treatments for non-age related skin conditions (e.g., dandruff, hair growth, etc.) or for conditions wholly unrelated to the skin.

Each set 32 of data comprises a list of genes and corresponding expression values representing up- and/or down-regulated genes selected to represent a condition of interest (e.g., effects of aging, dandruff, hair growth, skin moisture, etc.). In some embodiments, a first list may represent genes that are up-regulated as a result of the particular treatment and a second list may represent genes that are down-regulated as a result of the particular treatment. Gene names and/or gene symbols (or another nomenclature) and/or probe set IDs may be used to represent the individual genes for which data in the data 32 are included. Additional data may be stored with the digital file 30 and this is commonly referred to as metadata, which may include any associated information, for example, cell line or sample source, and microarray identification. In some embodiments, one or more gene expression profiles may be stored in a plurality of digital files and/or stored on a plurality of computer readable media. In other embodiments, a plurality of genetic expression profiles may be stored in the same digital file (e.g., 30) or stored in the same digital file or database that comprises the instances 22, 24, and 26.

The second digital file 30 also comprises one or more sets of control genomics data 33 and one or more sets of condition genomics data 34. Each of the sets 33 of control genomics data comprises a set of gene expression data for normal cells (i.e., cells unaffected by either the treatment or the condition). Similarly, each of the sets 34 of condition genomics data comprises a set of gene expression data for cells having the condition for which the treatment is targeted. The digital file 30 may include sets 33 of control genomics data and sets 34 of condition genomics data for one type of cell or multiple types of cells and/or for one condition or multiple conditions. For example, with reference to treatments for the effects of aging on skin, the digital file 30 may include sets 33 of control genomics data for young skin cells exposed to ultraviolet (UV) radiation (e.g., skin cells on the arm) and may also include sets 33 of control genomics data for young skin cells not exposed to UV radiation (e.g., skin cells on the buttocks). Similarly, the digital file 30 may include sets 34 of condition genomics data for old skin cells exposed to UV radiation and may also include sets 34 of condition genomics data for old skin cells not exposed to UV radiation. Gene names and/or gene symbols (or another nomenclature) and/or probe set IDs may be used to represent the individual genes for which data in the data sets 33, 34 are included. Additional data may be stored with the digital file 30 and this is commonly referred to as metadata, which may include any associated information, for example, cell line or sample source, and microarray identification. In some embodiments, one or more gene expression profiles may be stored in a plurality of digital files and/or stored on a plurality of computer readable media. In other embodiments, a plurality of genetic expression profiles may be stored in the same digital file (e.g., 30) or stored in the same digital file or database that comprises the instances 22, 24, and 26.

As will be described below, the control genomics data 33 and the condition genomics data 34 may be used to create clinical vectors representing the effect of the condition represented by the condition genomics data 34 relative to the control genomics data 33. However, in some embodiments, the control genomics data 33 and the condition genomics data 34 may be replaced with a single set of data representing the data that have already been analyzed to determine the effect. For example, the digital file 30 may include a set of data representing expression changes such as (without limitation) the log 2 fold change, standardized value (z-score), t-statistics, or normal quantile between the control and condition genomics data.

The digital file 30 may also include one or more sets of reference genomics data 35. The reference genomics data may include any database of genomics study data that compares includes data of a multiplicity of materials and conditions. For example, in one embodiment, the reference genomics data includes gene expression profile data from studies of more than 2,000 materials and conditions. As will be described in detail below, the reference genomics data are used to provide a background distribution of the effects of materials and conditions, which background distribution allows the assignment of statistical significance to various vector distances determined by the method.

The data stored in the first and second digital files 20, 30 may be stored in a wide variety of data structures and/or formats, such as the data structures and/or formats described herein. In some embodiments, the data is stored in one or more searchable databases, such as free databases, commercial databases, or a company's internal proprietary database. The database may be provided or structured according to any model, such as, for example and without limitation, a flat model, a hierarchical model, a network model, a relational model, a dimensional model, or an object-oriented model. In some embodiments, at least one searchable database is a proprietary database. A user of the system 10 may use a graphical user interface associated with a database management system to access and retrieve data from the one or more databases or other data sources to which the system is communicatively coupled. In some embodiments, the first digital file 20 is provided in the form of a first database and the second digital file 30 is provided in the form of a second database. In other embodiments, the first and second digital files may be combined and provided in the form of a single file.

In some embodiments, the first digital file 20 may include data that are transmitted across the communication network 18 from a digital file 36 stored on the computer readable medium 38. In one embodiment, the first digital file 20 may comprise gene expression data obtained from a cell line (e.g., a nasal epithelial cell line, a cancer cell line, etc.) as well as data from the digital file 36, such as gene expression data from other cell lines or cell types, perturbagen information, clinical trial data, scientific literature, chemical databases, pharmaceutical databases, and other data and metadata. The digital file 36 may be provided in the form of a database.

The computer readable medium 16 (or another computer readable media) may also have stored thereon one or more digital files 28 comprising computer readable instructions or software for reading, writing to, or otherwise managing and/or accessing the digital files 20, 30. The computer readable medium 16 may also comprise software or computer readable and/or executable instructions stored in one or more digital files 28 that cause the computing device 12 to perform one or more methods described herein, including for example and without limitation, methods (or portions of methods) associated with comparing a gene expression profile data (e.g., treatment and control gene expression data) stored in the digital file 30 according to the sets of genes 22, 24, and 26 corresponding to different target biological processes and pathways and stored in digital file 20, methods (or portions of methods) for computing log fold changes, methods of creating and/or compiling change vectors, methods for computing vector distances between vectors, methods for compiling and analyzing distributions, etc. In some embodiments, the one or more digital files 28 form part of a database management system for managing the digital files 20, 30.

The computer readable medium 16 may form part of or otherwise be connected to the computing device 12. The computing device 12 can be provided in a wide variety of forms, including but not limited to any general or special purpose computer such as a server, a desktop computer, a laptop computer, a tower computer, a microcomputer, a mini computer, a tablet computer, a smart phone, and a mainframe computer. While various computing devices may be suitable for use with the invention, a generic computing device 12 is illustrated in FIG. 2. The computing device 12 may comprise one or more components selected from a processor 40, system memory 42, and a system bus 44. The system bus 44 provides an interface for system components including, but not limited to, the system memory 42 and processor 40. The system bus 44 can be any of several types of bus structures that may further interconnect to a memory bus (with or without a memory controller), a peripheral bus, and a local bus using any of a variety of commercially available bus architectures. Examples of a local bus include an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus. The processor 40 may be selected from any suitable processor, including but not limited to, dual microprocessor and other multi-processor architectures. The processor executes a set of stored instructions associated with one or more program applications or software.

The system memory 42 can include non-volatile memory 46 (e.g., read only memory (ROM), erasable programmable read only memory (EPROM), electrically erasable programmable read only memory (EEPROM), etc.) and/or volatile memory 48 (e.g., random access memory (RAM)). A basic input/output system (BIOS) can be stored in the non-volatile memory 38, and can include the basic routines that help to transfer information between elements within the computing device 12. The volatile memory 48 can also include a high-speed RAM, such as static RAM for caching data.

The computing device 12 may further include a storage 44, which may comprise, for example, an internal hard disk drive (HDD) (e.g., enhanced integrated drive electronics (EIDE) or serial advanced technology attachment (SATA)) for storage. The computing device 12 may further include an optical disk drive 46 (e.g., for reading a CD-ROM or DVD-ROM 48). The drives and associated computer-readable media provide non-volatile storage of data, data structures and the data architecture of the invention, computer-executable instructions, and so forth. For the computing device 12, the drives and media accommodate the storage of any data in a suitable digital format. Although the description of computer-readable media above refers to a HDD and optical media such as a CD-ROM or DVD-ROM, it should be appreciated by those skilled in the art that other types of media which are readable by a computer, such as Zip disks, magnetic cassettes, flash memory cards, cartridges, and the like may also be used, and further, that any such media may contain computer-executable instructions for performing the inventive methods. Of course, the computer readable medium 16, comprising the digital files 20, 28, and 30, may be the same as the system memory 42 and/or the storage 44.

A number of software applications can be stored on the drives 44 and volatile memory 48, including an operating system and one or more software applications, which implement, in whole or part, the functionality and/or methods described herein. It is to be appreciated that the embodiments can be implemented with various commercially available operating systems or combinations of operating systems. The central processing unit 40, in conjunction with the software applications in the volatile memory 48, may serve as a control system for the computing device 12 that is configured to, or adapted to, implement the functionality described herein.

A user may be able to enter commands and information into the computing device 12 through one or more wired or wireless input devices 50, for example, a keyboard, a pointing device, such as a mouse (not illustrated), or a touch screen. These and other input devices are often connected to the central processing unit 40 through an input device interface 52 that is coupled to the system bus 44 but can be connected by other interfaces, such as a parallel port, an IEEE 1394 serial port, a game port, a universal serial bus (USB) port, an IR interface, etc. The computing device 12 may drive a separate or integral display device 54, which may also be connected to the system bus 44 via an interface, such as a video port 56.

The computing devices 12, 14 may operate in a networked environment across network 18 using a wired and/or wireless network communications interface 58. The network interface port 58 can facilitate wired and/or wireless communications. The network interface port can be part of a network interface card, network interface controller (NIC), network adapter, or LAN adapter. The communication network 18 can be a wide area network (WAN) such as the Internet, or a local area network (LAN). The communication network 18 can comprise a fiber optic network, a twisted-pair network, a T1/E1 line-based network or other links of the T-carrier/E carrier protocol, or a wireless local area or wide area network (operating through multiple protocols such as ultra-mobile band (UMB), long term evolution (LTE), etc.). Additionally, communication network 18 can comprise base stations for wireless communications, which include transceivers, associated electronic devices for modulation/demodulation, and switches and ports to connect to a backbone network for backhaul communication such as in the case of packet-switched communications.

### II. Methods for Evaluating Effects of a Treatment

While described herein primarily with regard to treatments related to skin care and effects (e.g., anti-aging effects) of such treatments, the methods herein set forth are applicable to a variety of treatment areas including, without limitation, treatments related to hair care, oral care, grooming, and the like. Generally, the methods may be employed to identify biological processes and/or pathways on which any ingredient or compound shows beneficial effects for a given purpose. For ease of discussion, the following disclosure refers to specific treatments, biological processes and pathways, beneficial effects, and product areas. However, this discussion will be understood by those of ordinary skill in the art as exemplary and non-limiting. Additionally, while the methods and systems are described with relation to “biological processes,” it will be understood by those of ordinary skill in the art that, in general, the phrase should be understood to include biological pathways, even though not always explicitly stated. The reverse is also true—use of the phrase “biological pathways” will be understood, in general, to include biological processes.

In general, the method computes a distance between two vectors (i.e., a vector distance), and determines the statistical significance of the vector distance to assess the effect of a treatment on a particular biological pathway. The first of the two vectors is a set of expression changes representing the treatment effect of an ingredient on genes in the biological pathway, and includes one value for each of the genes in the biological pathway. The second of the vectors is a set of expression changes representing the effect of the condition on the genes of the biological pathway. By comparing the vector distance between the two vectors against an empirical distribution of vector distances, the significance of the effect of the treatment on the biological pathway can be determined. The genes corresponding to each biological pathway/process and represented in each of the vectors are specified by Gene Ontology, KEGG pathway, WikiPathway, and/or any other known source.

While described herein primarily as a cosine distance, and with reference to formulas for calculating cosine distances and using the cosine distances in the remainder of the method, the vector distance may be any distance measurement between two vectors, including, by way of example and without limitation, Euclidian distance, Mahalanobis distance, Manhattan distance, Chebyshev distance, Minkowski distance, and the like. Accordingly, any embodiment described herein as implementing a cosine distance may alternatively implement any other vector distance, and the use of cosine distance shall in examples shall not be construed as limiting.

In the case of a study of the effects of a particular agent, Pal-KTTKS (e.g., at 3 ppm concentrations), on aging of skin cells, for example, a particular biological process may be targeted. For each of the genes in the target biological process, the expression changes (e.g., log 2 fold changes) between old and young cells may be calculated for cells exposed to ultraviolet (UV) radiation (e.g., cells taken from the arms), for cells not exposed to UV radiation (e.g., cells taken from the buttocks), or for both. That is, the condition genomics data 34 may be compared to the control genomics data 33 to determine the expression change for each of the genes in the target biological process. The expression changes between treated and untreated cells may also be calculated for each of the genes in the target biological process, which in some implementations may include comparing the control genomics data 33 to the treatment genomics data 32. Each set of expression changes (where each set comprises an expression change for each of the genes in the target biological process) forms a corresponding vector, and the vector for the treatment effect (also referred to hereafter as the “treatment vector”) is compared to the vector for the reference effect (e.g., the vector for old/young cells), which is also referred to herein as a “clinical vector,” by taking the distance (e.g., cosine distance) between the vectors.

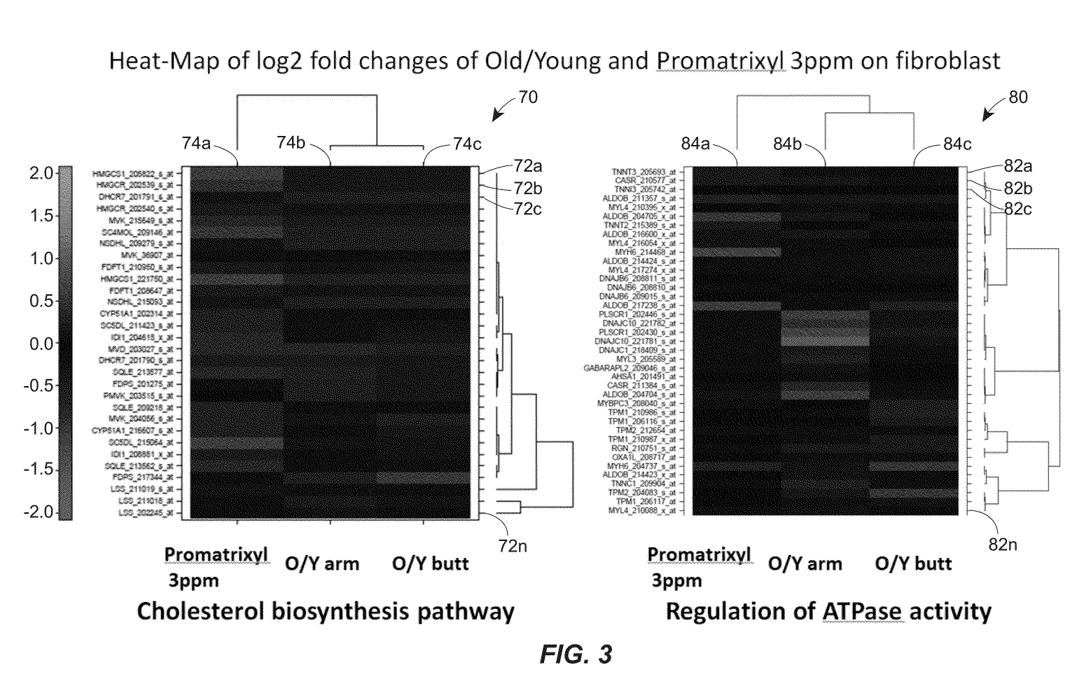

FIG. 3 depicts heat maps 70, 80 representing exemplary expression change data (in this example, log 2 fold change data) for Pal-KTTKS (3 ppm) relative to both UV- and non-UV-exposed skin cells for each of two different target biological pathways. Specifically, the heat map 70 depicts data for the cholesterol biosynthesis pathway and the heat map 80 depicts data for the ATPase regulation pathway. In each of the heat maps 70, 80, each row 72a-n, 82a-n depicts one gene in the corresponding target biological pathway, where n is the number of genes in the target biological pathway. Each heat map 70, 80 includes three columns 74a-c, 84a-c, which columns represent, respectively, the log 2 fold change for cells exposed to the treatment ingredient or compound, for UV-exposed skin cells, and non-UV-exposed skin cells. Accordingly, the column 74a represents the treatment vector for the target biological pathway represented in the heat map 70 (e.g., the cholesterol synthesis pathway), and each of the columns 74b and 74c represents a clinical vector for the target biological pathway represented in the heat map 70. Similarly, the column 84a represents the treatment vector for the target biological pathway represented in the heat map 80 (e.g., the ATPase regulation pathway), and each of the columns 84b and 84c represents a clinical vector for the target biological pathway represented in the heat map 80.

Specific methods and calculations will now be described using the examples above in which the target treatment is Pal-KTTKS (and others) and the target condition is aging of skin cells. Throughout, UV-mediated aging may also be referred to as “photo-aging,” and cells subject to photo-aging may be referred to as “UV-exposed skin cells” or “skin cells exposed to UV radiation.” Similarly, non-UV-mediated aging may also be referred to as “intrinsic aging,” and cells subject to intrinsic aging may be referred to as “non-UV-exposed skin cells.” The treatment effect—in this case the anti-aging effect—of a specified ingredient (e.g., Pal-KTTKS) is measured by the vector distance (e.g., cosine distance) between two vectors of expression changes (e.g., log 2 fold expression changes) of genes in a target biological process. One of the vectors compares treatment genomics data for the genes with control genomics data for the genes to represent the treatment effects on the genes (i.e., a “treatment effect vector” or “treatment vector” of the ingredient). The other vector (referred to herein as a “condition effect vector,” a “condition vector,” or a “clinical vector”) compares condition genomics data for the genes with control genomics data for the genes to represent the effects of the condition on the genes in the target biological process. In the case of the present example, the clinical vector would compare gene expression between skin samples of old and young skin.

The values of each vector are described and depicted herein as log 2 fold change values for each of the genes in the target biological pathway. In embodiments, the log 2 fold changes are values averaged over a multiplicity of replicates. However, it is also possible to use (instead of log 2 fold changes) as values of the vectors standard normal quantile (two-tail) or t-statistic from p-values or standardized values (z-score) from dedicated genomics studies, or other quantitative measures of expression change.

In any event, for a target biological process, i, the vector distance, distᵢ, between the treatment and clinical vectors is calculated, by way of example as a cosine distance, according to

$${dist}_{i} = {cos}_{i} = \frac{{v\_tret}_{i} \cdot {v\_ref}_{i}}{\vert {v\_tret}_{i} \vert \vert {v\_ref}_{i} \vert} \qquad ( Equ . 1 )$$

where cosᵢ represents the cosine distance, and v_tretᵢ and v_refᵢ are the treatment effect vector and the clinical vector, respectively, for the i-th target biological process. Each of v_tretᵢ and v_refᵢ consists of values for k genes {c_tretᵢ₁, c_tretᵢ₂, . . . , c_tretᵢₖ} and {c_refᵢ₁, c_refᵢ₂, . . . , c_refᵢₖ} associated with the i-th target biological process (according to, for example, one of the sets 22, 24, 26 of genes in the file 20) and, in particular, values representing the difference in expression of each of the genes in the presence and absence of the treatment, and in the presence and absence of the condition, respectively. Accordingly, each vector may be represented as:

v_{—}tretᵢ={c_{—}tretᵢ₁,c_{—}tretᵢ₂, . . . ,c_{—}tretᵢₖ}

v_{—}refᵢ={c_{—}refᵢ₁,c_{—}refᵢ₂, . . . ,c_{—}refᵢₖ} (Equ. 2,3)

For a given target biological process i, the vector distance cosᵢ represents the effect of the treatment (i.e., the ingredient or compound) relative to the condition. For example, when using cosine distance, the values of the cosine distance span from negative one to positive one [−1,1], and are proportional to the effect of the treatment. A positive cosine value means that the treatment effect vector is projected onto the clinical vector in the same direction, and, therefore, that the treatment is increasing the effects of the condition. A negative cosine value means that the treatment effect vector is projected onto the clinical vector in the opposite direction and, therefore, indicates an effect of the treatment opposite that of the condition. That is, a cosine value of negative one suggests that the treatment ingredient or compound causes an expression exactly opposite that of the condition for the target biological pathway. However, any other quantitative vector distance between two vectors such as Euclidean distance, Mahalanobis distance, Manhattan distance, Chebyshev distance, Minkowski distance, or any other similar measure can alternatively be used as an effect measurement of the treatment in the same way as the cosine distance to address treatment effect compared to clinical condition.

While the vector distance for a treatment and a target biological pathway is indicative of the effect of the treatment on the target biological pathway, the vector distance by itself is not indicative of the significance of the effect relative to other effects on other biological pathways. The statistical significance of a particular vector distance may be extrapolated from an empirical distribution of vector distances calculated using reference genomics data such as connectivity map (CMap) genomics data. For example, a particular set of genomics data (e.g., the Affy U133A 2.0 platform) may include approximately 3,000 instances on a keratinocyte cell line, and approximately 1,500 instances on a fibroblast cell line. The former may consist of 1,400 unique treatment ingredients/compounds and conditions, while the latter may consist of 650 unique treatment ingredients/compounds and conditions. An empirical distribution of vector distances may be generated from this large set of reference genomics data and, from the empirical distribution, the significance of the vector distance between the treatment and the clinical vector may be imputed from the percentile of the vector distance among those in the distribution.

The empirical distribution is constructed from a set of vector distances (e.g., cosine distances), DISTᵢ, for the i-th target biological process. The set of vector distances is computed according to

DISTᵢ={dist_{i,1},dist_{i,2}, . . . ,dist_{i,s}} (Equ. 4)

where dist_{i,j} is the vector distance between the reference treatment vector for the j-th instance/material and the clinical vector on the i-th target biological pathway, computed, when using a cosine distance, according to

$${dist}_{i , j} = {b\_cos}_{i , j} = \frac{{v\_back}_{i , j} \cdot {v\_ref}_{i}}{\vert {v\_back}_{i , j} \vert \vert {v\_ref}_{i} \vert} . \qquad ( Equ . 5 )$$

and v_back is expression change vector between the reference instance and the clinical instance (if v_tret and v_ref are expression change vectors). Alternatively, but not necessarily, v_back may be a vector of standardization values (z-scores) from all instances within the same batch or standard normal quantile or t-statistic from p-value.

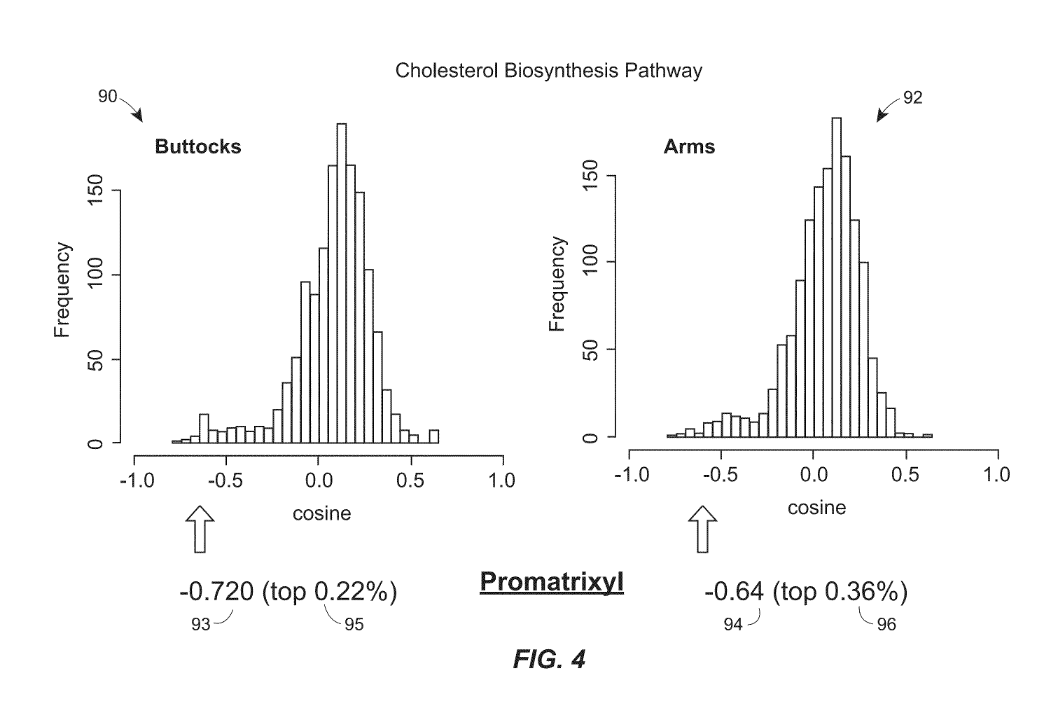

FIG. 4 depicts example distributions 90, 92, which distributions represent the frequency of vector distances (in this case cosine distances) generated from the reference genomics data for the cholesterol biosynthesis pathway for non-UV-exposed and UV-exposed skin cells, respectively. That is, the distribution 90 indicates, for the cholesterol biosynthesis pathway, the frequency with which the vector for one of the ingredients in the reference genomics data had a particular cosine distance from the clinical vector for non-UV-exposed skin. Similarly, the distribution 92 indicates, for the cholesterol biosynthesis pathway, the frequency with which the vector for one of the ingredients in the reference genomic had a particular cosine distance from the clinical vector for UV-exposed skin. Put another way, the distributions 90, 92 represent how often a set of ingredients would strongly affect the cholesterol biosynthesis pathway for non-UV-exposed skin cells and UV-exposed skin cells, respectively.

Using the distributions, a percentile may be calculated for the vector distance between the clinical and treatment vectors. Specifically, the percentile among the extreme region of the distribution for the i-th target biological process is calculated according to

$${n\_per}_{i} = \frac{size ( {DIST}_{i} \leq {dist}_{i} )}{size ( {DIST}_{i} )} \times 100 \qquad ( Equ . 6 )$$

where size(DISTᵢ≦distᵢ) indicates the number of elements less than or equal to distᵢ in the set of DISTᵢ and size(DISTᵢ) indicates the total number in the set. The percentile n_perᵢ for the i-th biological process is used as a measure of the significance of the treatment effect on the i-th biological process. Depending on the clinical and conditional study, extreme regions of higher percentiles can also be of interest.

Referring again to FIG. 4, the vector (cosine) distance 93, 94, and the corresponding percentile 95, 96 in the calculated empirical distributions from fibroblast reference genomics data, is shown for Pal-KTTKS treatment (3 ppm on fibroblast cells) of both intrinsic aging (i.e., on non-UV-exposed cells) and UV-mediated aging (i.e., on UV-exposed cells). As apparent in FIG. 4, Pal-KTTKS treatment shows very strong negative cosine distance values with the intrinsic aging vector (−0.720) and the photo aging vector (−0.640). The vector distances, considered among the distributions calculated from the reference genomics data, result in calculated percentiles of 0.22 and 0.36, respectively, establishing that Pal-KTTKS provides a strong anti-aging benefit on the cholesterol synthesis pathway for both intrinsic and UV-mediated aging.

Of course, to this point the specification has described the application of the method to a single treatment and a single target biological pathway which, as applied, facilitates evaluation of the effectiveness of a particular treatment on the target biological pathway. However, in order to identify any biological processes on which a beneficial treatment effect may be established, the method as described thus far may be applied to any available biological processes. For example, the method may be applied to each of the biological processes/pathways having at least 5 genes in each of the Gene Ontology, KEGG, and WikiPathway databases (which results in a total of approximately 4,500 biological processes/pathways). Accordingly, there would be one percentile calculated for each of the target biological pathways evaluated, resulting in a set of percentile values N_Per expressed as

N_{—}Per={n_{—}per₁,n_{—}per₂, . . . ,n_{—}perₙ} (Equ. 7)

where n is the number of total biological processes/pathways examined. A threshold percentile (e.g., 5%) may be selected to apply as a selection criteria for biological processes/profiles having a minimum significance. The set of biological processes having a beneficial method of action, BP_{MOA}, is the set of biological processes that have percentiles less than the threshold percentile:

BP_{MOA}={bpᵢ|n_{—}perᵢ≦threshold,i=1,2, . . . ,n} (Equ. 8)

where bpᵢ is the i-th biological process. Depending on the clinical and conditional studies, extreme regions of higher percentiles can be of interest in some embodiments. In some implementations, the distribution of the percentiles of all of the biological processes is examined to determine whether the distribution is skewed from a uniform distribution, which would suggest no strong treatment effect at all.

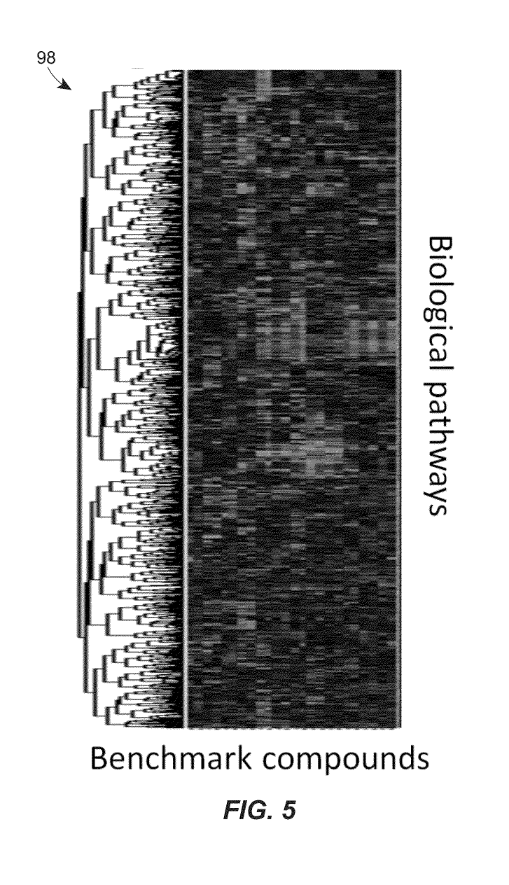

In some implementations, the significances of a set of treatments (i.e., ingredients and/or compounds) on a set of biological processes is displayed (e.g., on a computer display or printed page) as a pictorial representation which can be useful in understanding complex patterns that may emerge from the results. The pictorial representation may include, for example, a heat map. In an embodiment, the heat map is constructed from standardization values instead of percentiles. The standardization values may be calculated from the vector distances, for example, according to

$${std\_effect}_{i} = \frac{{dist}_{i , 1} - mean ( {DIST}_{i} )}{sd ( {DIST}_{i} )} \qquad ( Equ . 9 )$$

where std_effectᵢ is the standardization value, mean and sd are functions to compute mean and standard deviation, respectively, for the set of vector distances on the i-th biological processes (DISTᵢ). Depending on the context, a positive standardized value indicates a beneficial effect (e.g., a beneficial anti-aging effect) and a negative standardized value indicates no beneficial effect. Of course, in some contexts, a positive standardized value could indicate an adverse or negligible effect, while a negative standardized value could indicate a beneficial effect. FIG. 5 shows an example heat map 98 depicting the standardized anti-aging effects of all of the biological processes defined by the Gene Ontology database for 24 different ingredients and/or compounds.

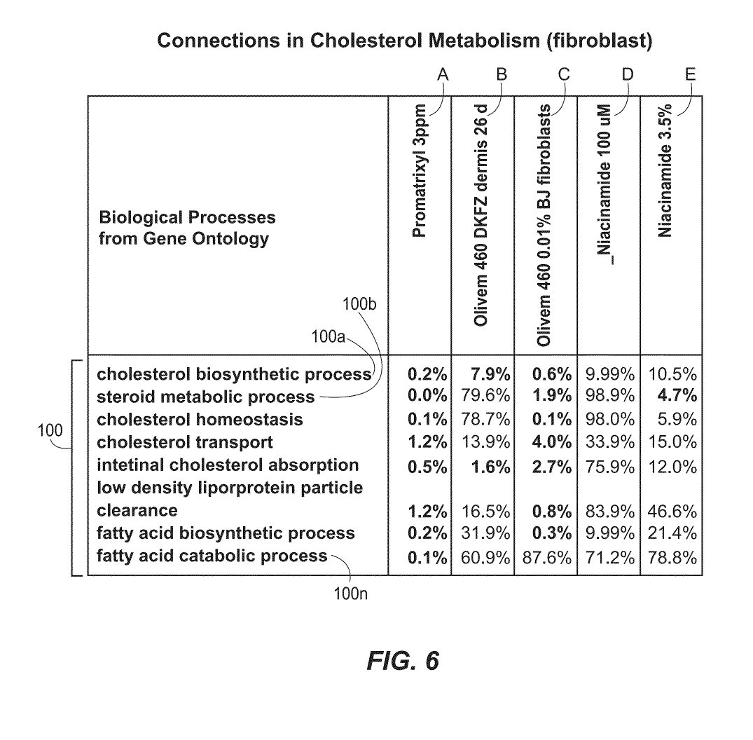

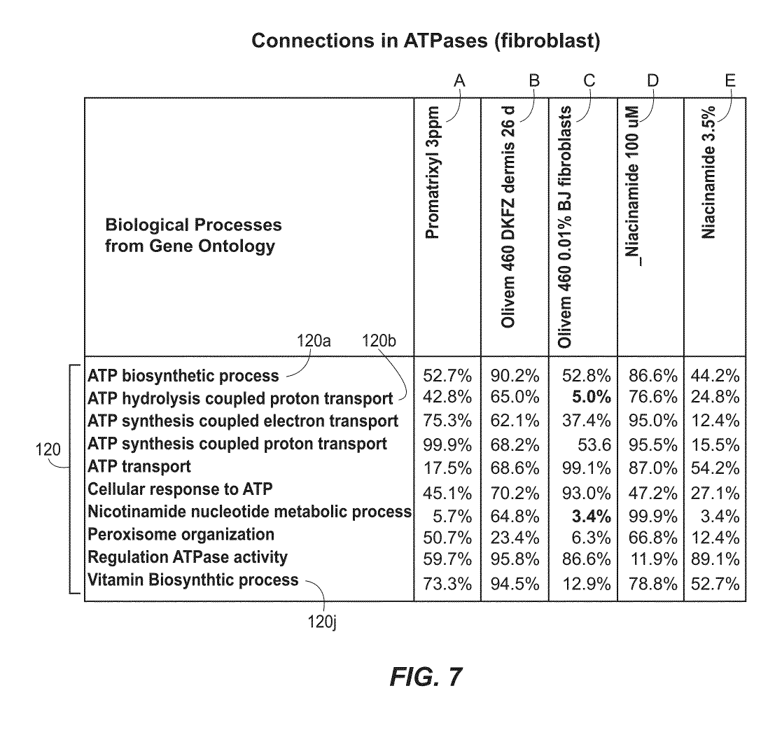

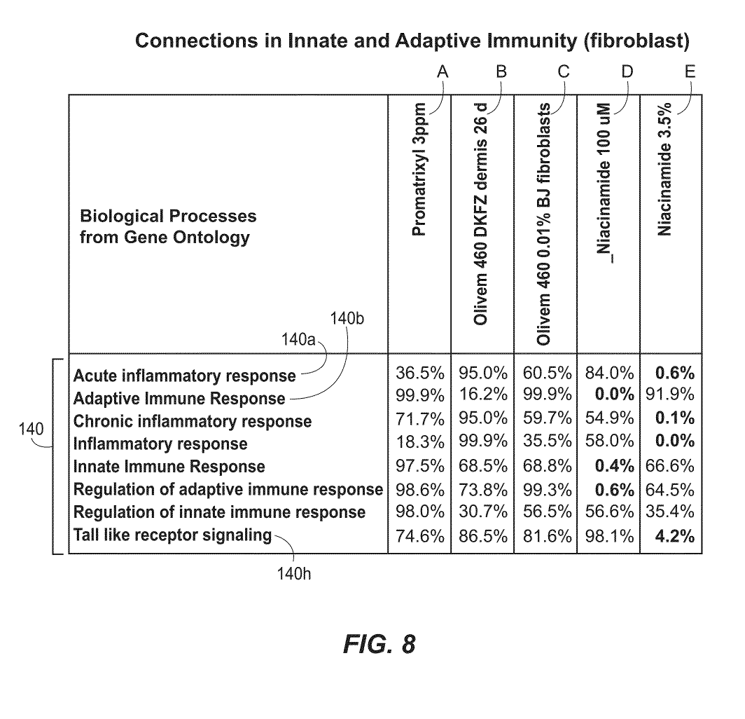

FIGS. 6, 7, and 8 show exemplary data for three sets of biological processes/pathways from the Gene Ontology database including a set 100 of cholesterol metabolism processes/pathways (FIG. 6), a set 120 of ATPase regulation processes/pathways (FIG. 7), and a set 140 of innate and adaptive immunity processes/pathways (FIG. 8). For each set of processes and pathways, a variety of individual processes and pathways 100a-h, 120a-j, 140a-h form the rows of a chart and, for each process or pathway, a five treatment ingredients/formulations form the columns of the chart. For each of the formulations A-E, a percentile is listed for each of the biological processes and pathways.

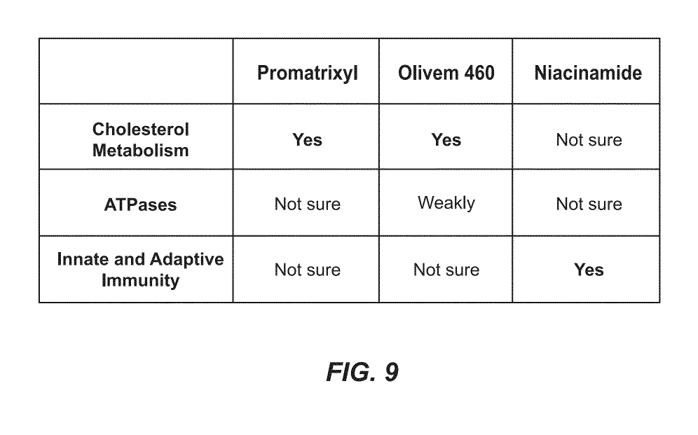

Looking in particular at FIG. 6, it can be seen that Pal-KTTKS 3 ppm has very low percentile values for each of the biological processes/pathways 100a-h, indicating that Pal-KTTKS 3 ppm has a very strong effect on the cholesterol metabolism processes/pathways associated with fibroblasts. A similar analysis applies to Olivem 460, at least with respect to the formulation in column C. With respect to Niacinamide (columns D and E) only a single biological process (i.e., 100b, steroid metabolic process) exhibits a percentile below the exemplary 5% threshold, indicating that Niacinamide likely does not strongly affect the cholesterol metabolism pathways and processes. Looking at FIG. 7, it becomes apparent that Pal-KTTKS and Niacinamide have almost no effect on any of the ATPase regulation processes/pathways, while Olivem 460 (column C) exhibits an effect on certain ones of the ATPase regulation processes/pathways (e.g., ATP hydrolysis coupled proton transport, 120b, and Nicotinamide nucleotide metabolic process, 120g), but only a weak effect on the ATPase regulation processes/pathways overall. Meanwhile, in the innate and adaptive immunity processes/pathways included in FIG. 8, many of the percentile values for the Niacinamide compounds are below the example 5% threshold, indicating a strong effect of Niacinamide for the set 140 of pathways. The analysis of the data in FIGS. 6, 7, and 8 is summarized in FIG. 9.

In embodiments, the biological processes and pathways identified via the described methods and systems as most beneficially affected by a treatment ingredient or compound may be associated with particular benefits and/or mapped to consumer terms, and those benefits and/or consumers terms may be brought to the attention of interested persons (e.g., marketing professionals, clinicians, retail consumers, researchers, etc.). For example, and with reference again to the anti-aging study, biological processes or pathways may be mapped to consumer-relatable terms such as, by way of example and without limitation: wrinkles, skin barrier, mechanical firmness, texture, hydration, radiance, elasticity, etc. By facilitating identification of the biological processes and pathways most beneficially affected by a treatment ingredient or compound, the described methods and systems assist in promoting to consumers and clinicians and providing scientific credentialing, for example, the benefits of a product that includes the treatment ingredient or compound.

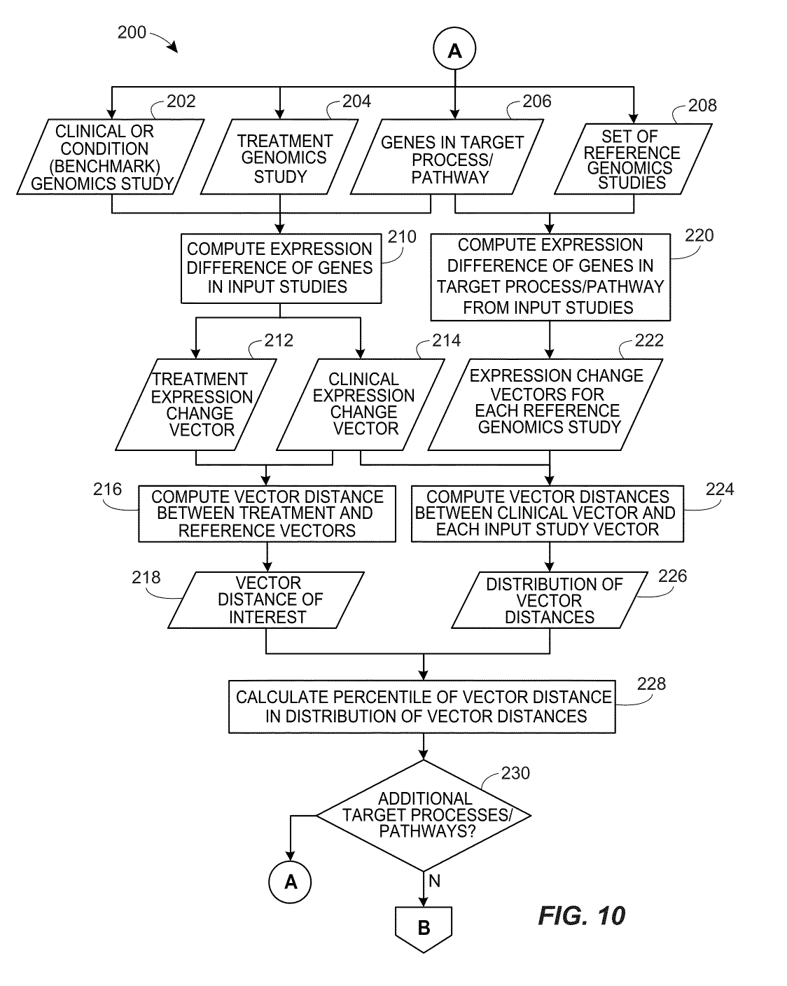

Turning now to FIG. 10, a flow chart depicts an example method 200 for identifying treatments with beneficial mechanisms of action. The method 200 will be generally understood as corresponding to the methods described above, and the exact order and set of set operations depicted in the method 200 is intended to be illustrative rather than limiting. The method 200 is executed by a computer processor, such as the processor 40 described with reference to FIG. 2, according to computer-readable instructions stored on a tangible (i.e., non-transitory) device. Input and output data are also stored on a tangible device.

The processor retrieves data from a memory device, which data includes more clinical genomics study data (block 202), treatment genomics data (block 204), genes in one or more target processes/pathways (block 206), and one or more sets of reference genomics studies (block 208). For the genes in a first target process or pathway, the processor computes expression changes (block 210) for those genes in the clinical genomics study data to determine a clinical vector (block 212), and computes expression changes (or standardized values) for those genes in the treatment genomics study data to determine a treatment vector (block 214). The processor then computes a vector distance of interest (block 218) between the treatment vector and the clinical vector (block 216).

The processor also computes the expression changes (block 220) for the genes in the first target process or pathway for each of the reference genomics studies to determine a set of reference vectors (block 222). The processor computes the vector distance between the clinical vector and each of the set of reference vectors (block 224) to create a distribution of vector distances (block 226). The processor computes a percentile value for the vector distance of interest relative to the distribution of vector distances (block 228).

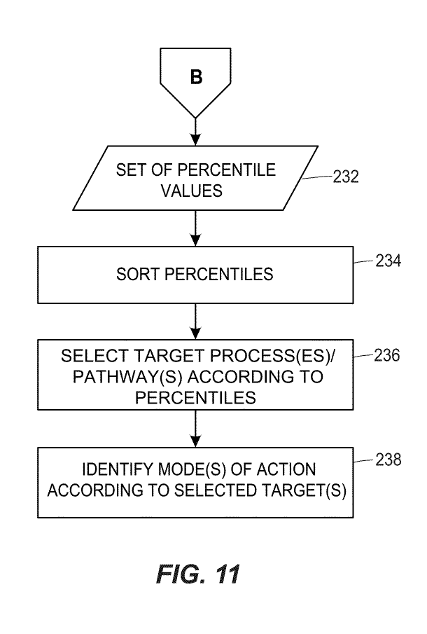

If there are additional target processes and/or pathways to evaluate (block 230), the processor repeats the method (blocks 202-228) for each of the target processes and/or pathways. With reference to FIG. 11, when there are no additional target processes and/or pathways, the processor will have generated via the method a set of percentile values (block 232). In embodiments, the set of percentiles is sorted (block 234), and target process(es) and/or pathway(s) are selected according to the lowest percentiles (block 236) by, for example, selecting processes or pathways that have percentiles at or below a predetermined threshold value. Beneficial mechanisms of action may be identified according to the selected target processes and/or pathways (block 238).

Unless otherwise specified, the terms “computing,” “calculating,” “determining,” and “processing” are used interchangeably to indicate the manipulation and/or analysis of data, by a computer processor, to produce a result.

The values disclosed herein are not to be understood as being strictly limited to the exact numerical values recited. Instead, unless otherwise specified, each such value is intended to mean both the recited value and a functionally equivalent range surrounding that value.

The invention should not be considered limited to the specific examples described herein, but rather should be understood to cover all aspects of the invention. Various modifications, equivalent processes, as well as numerous structures and devices to which the invention may be applicable will be readily apparent to those of skill in the art. Those skilled in the art will understand that various changes may be made without departing from the scope of the invention, which is not to be considered limited to what is described in the specification.

What is claimed is:

1. A computer-implemented method for evaluating effects of a treatment, the method comprising:
for each of one or more biological processes or pathways:
computing, using a processor, a treatment vector;
computing, using a processor, a clinical vector;
computing, using a processor, a vector distance between the treatment and clinical vectors;
computing, using a processor, a set of reference vectors;
computing, using a processor, a set of vector distances comprising vector distances between the clinical vector and each of the set of reference vectors;
determining, using a processor, a distribution of the set of vector distances; and
calculating, using a processor, a percentile of the vector distance in the distribution of the set of vector distances.

2. The method of claim 1, wherein the one or more biological processes or pathways comprise a plurality of biological processes or pathways, and further comprising sorting the percentiles by ascending order.

3. The method of claim 2, wherein the one or more biological processes or pathways comprise a plurality of biological processes or pathways, and further comprising selecting as the target of the effect of the treatment biological processes or pathways having lower percentiles.

4. The method of claim 3, further comprising identifying a mechanism of action, technology product story, or power claim of the treatment according to the selected biological processes or pathways.

5. The method of claim 1, wherein computing the treatment vector comprises computing expression changes of genes in a biological process or pathway as a result of the treatment.

6. The method of claim 1, wherein computing the clinical vector comprises computing expression changes of genes in a biological process or pathway as a result of a non-treatment variable.

7. The method of claim 1, wherein computing each of the clinical, treatment, and reference vectors comprises computing a standard normal quantile or t-statistic of p-value.

8. The method of claim 1, wherein computing each of the clinical, treatment, and reference vectors comprises computing standardized value (z-score).

9. The method of claim 1, wherein computing a vector distance between the treatment and clinical vectors comprises computing the cosine distance according to:
$${cos}_{i} = \frac{{v\_treat}_{i} \cdot {v\_ref}_{i}}{\vert {v\_treat}_{i} \vert \vert {v\_ref}_{i} \vert}$$
where v_treatᵢ and v_refᵢ are vectors, i is the i-th biological process or pathway, and
v_treatᵢ={c_treatᵢ₁,c_treatᵢ₂, . . . ,c_treatᵢₖ}
v_{—}refᵢ={c_{—}refᵢ₁,c_{—}refᵢ₂, . . . ,c_{—}refᵢₖ}
representing changes in gene expression of k genes in the biological process or pathway.

10. The method of claim 1, wherein the method evaluates anti-aging effects of an ingredient or compound on skin cells.

11. The method of claim 10, wherein the first reference vector is computed from a comparison of old and young skin cell samples.

12. The method of claim 1, wherein determining a distribution of the set of vector distances comprises determining the distribution according to:
$${DIST}_{i} = \{ {dist}_{i , 1} , {dist}_{i , 2} , … , {dist}_{i , s} \}$$
$${dist}_{i , j} = \frac{{v\_back}_{i , j} \cdot {v\_ref}_{i}}{\vert {v\_back}_{i , j} \vert \vert {v\_ref}_{i} \vert}$$
where
DISTᵢ is a set of vector distance values for the i-th biological process,
dist_{i,j} is vector distance between a j-th reference vector and the clinical vector for the i-th biological process,
s is the size of the set of reference vectors, and
v_back_{i,j} is the change vector between the j-th reference vector and the clinical vector for the i-th biological process.

13. The method of claim 1, wherein calculating a percentile of the vector distance in the distribution of the set of vector distances comprises calculating the percentile according to:
$${n\_per}_{i} = \frac{size ( {DIST}_{i} \leq {dist}_{i} )}{size ( {DIST}_{i} )} \times 100$$
where size(DISTᵢ . . . ) indicates the number of elements less than or equal to distᵢ in the set of DISTᵢ, and
size(DISTᵢ) indicates the total number of the set.

14. The method of claim 1, further comprising, for each of the one or more biological processes or pathways, determining, according to the percentile, whether the treatment demonstrates a significant effect on the biological process or pathway.

15. The method of claim 14, wherein determining whether the treatment demonstrates a significant effect on the biological process or pathway comprises determining whether the percentile is below a pre-determined threshold.

16. The method of claim 14, further comprising, for any biological process or pathway on which it is determined the treatment demonstrates a significant effect, mapping the biological process or pathway to a consumer-relatable term.

17. The method of claim 1, wherein computing the vector distance comprises computing cosine distance.

18. The method of claim 1, wherein computing the vector distance comprises computing Euclidian distance.

19. The method of claim 1, wherein computing the vector distance comprises computing Mahalanobis distance.

20. The method of claim 1, wherein computing the vector distance comprises computing Manhattan distance.

21. The method of claim 1, wherein computing the vector distance comprises computing Chebyshev distance.

22. The method of claim 1, wherein computing the vector distance comprises computing Minkowski distance.

23. The method of claim 1, wherein computing each of the clinical, treatment, and reference vectors comprises computing for each a log 2 fold change.

24. A system for evaluating effects of a treatment, the system comprising:
a computer processor;
one or more memory devices coupled to the computer processor and storing:
a listing of genes associated with a target process or pathway;
a set of treatment genomics data demonstrating effects of the treatment on a set of genes including at least the genes associated with the target process or pathway;
a set of clinical genomics data demonstrating effects of a target characteristic on a set of genes including at least the genes associated with the target process or pathway;
a set of reference genomics data representing the effects of various materials and/or conditions on a set of genes including at least the genes associated with the target process or pathway; and
a set of machine readable instructions operable to cause the processor to:
compute a treatment vector using the treatment data;
compute a clinical vector using the clinical data;
compute a vector distance between the treatment vector and the clinical vector;
compute a set of reference vectors;
compute a set of vector distances between the clinical vector and each of the set of reference vectors;
determine a distribution of the set of vector distances; and
calculate a percentile of the vector distance in the set of vector distances.

25. The system of claim 24, wherein computing each of the clinical, treatment, and reference vectors comprises computing expression changes of genes in a biological process or pathway as a result of the treatment.

26. The system of claim 24, wherein computing each of the clinical, treatment, and reference vectors comprises computing expression changes of genes in a biological process or pathway as a result of a non-treatment variable.

27. The system of claim 24, wherein computing each of the clinical, treatment, and reference vectors comprises computing a standard normal quantile or t-statistic of p-value.

28. The system of claim 24, wherein computing each of the clinical, treatment, and reference vectors comprises computing standardized value.

29. The system of claim 24, wherein computing a vector distance between the treatment and clinical vectors comprises computing the cosine distance according to:
$${cos}_{i} = \frac{{v\_treat}_{i} \cdot {v\_ref}_{i}}{\vert {v\_treat}_{i} \vert \vert {v\_ref}_{i} \vert}$$
where v_treatᵢ and v_refᵢ are vectors, i is the i-th biological process or pathway, and
v_treatᵢ={c_treatᵢ₁,c_treatᵢ₂, . . . ,c_treatᵢₖ}
v_{—}refᵢ={c_{—}refᵢ₁,c_{—}refᵢ₂, . . . ,c_{—}refᵢₖ}
representing changes in gene expression of k genes in the biological process or pathway.

30. The system of claim 24, wherein determining a distribution of the set of vector distances comprises determining the distribution according to:
$${DIST}_{i} = \{ {dist}_{i , 1} , {dist}_{i , 2} , … , {dist}_{i , s} \}$$
$${dist}_{i , j} = \frac{{v\_back}_{i , j} \cdot {v\_ref}_{i}}{\vert {v\_back}_{i , j} \vert \vert {v\_ref}_{i} \vert}$$
where
DISTᵢ is a set of vector distance values for the i-th biological process,
dist_{i,j} is vector distance between a j-th genomics vector and the clinical vector for the i-th biological process,
s is the size of the set of reference vectors, and
v_back_{i,j} is the change vector between the j-th genomics vector and the clinical vector for the i-th biological process.

31. The system of claim 24, wherein calculating a percentile of the vector distance in the distribution of the set of vector distances comprises calculating the percentile according to:
$${n\_per}_{i} = \frac{size ( {DIST}_{i} \leq {dist}_{i} )}{size ( {DIST}_{i} )} \times 100$$
where size(DISTᵢ . . . ) indicates the number of elements less than or equal to distᵢ in the set of DISTᵢ,
distᵢ is the vector distance for the i-th element, and
size(DISTᵢ) indicates the total number of the set.

32. The system of claim 24, wherein computing each of the clinical, treatment, and reference vectors comprises computing a log 2 fold change.

33. The system of claim 24, wherein computing the vector distance comprises computing cosine distance.

34. The method of claim 24, wherein computing the vector distance comprises computing Euclidian distance.

35. The method of claim 24, wherein computing the vector distance comprises computing Mahalanobis distance.

36. The method of claim 24, wherein computing the vector distance comprises computing Manhattan distance.

37. The method of claim 24, wherein computing the vector distance comprises computing Chebyshev distance.

38. The method of claim 24, wherein computing the vector distance comprises computing Minkowski distance.
